(19) United States
(12) Patent Application Publication
(10) Pub. No.: US 2023/0371429 A1
(43) Pub. Date: Nov. 23, 2023

(54) SYSTEM AND METHOD FOR DE-SLUGGING A THRESHING SYSTEM OF AN AGRICULTURAL VEHICLE

(71) Applicant: CNH Industrial America LLC, New Holland, PA (US)

(72) Inventors: Edmund N. Holt, II, Denver, PA (US); Curtis Hillen, Lititz, PA (US)

(21) Appl. No.: 18/030,727

(22) PCT Filed: Oct. 7, 2021
(86) PCT No.: PCT/US21/53954

§ 371 Date: Apr. 6, 2023

Related U.S. Application Data
(60) Provisional application No. 63/088,580, filed on Oct. 7, 2020.

(51) Int. Cl. A01D 41/127

(52) U.S. Cl. CPC A01D 41/1274; A01D 41/1276

(57) ABSTRACT

In an agricultural combine including a rotor of a threshing system, a concave positioned beneath the rotor, a rotor cage positioned above the rotor, a drive controllably operable for rotating the rotor in opposite first and second rotational directions, a control in operative control of the drive, and a sensor for sensing information representative of load conditions opposing rotation of the rotor, a method for deslugging the threshing system of the agricultural combine includes the steps of (i) sensing information representative of load conditions opposing rotation of the rotor above a pre-determined threshold, which indicates a slugging condition; (ii) activating an actuator, which adjusts one or more components to move from an initial position to a deslugging position; (iii) rotating the rotor; and (iv) sensing information representative of load conditions opposing rotation to determine whether the slugging condition still exists.

### FIELD OF THE INVENTION

This invention relates generally to an agricultural combine, and more particularly, to a threshing system and operating method therefor, providing several semi- and fully automated operating modes for removing or dislodging a slug of crop and/or other material from the threshing system and/or a feeder of the combine for conveying crop material to the threshing system.

### BACKGROUND OF THE INVENTION

As is described in U.S. Pat. No. 7,452,267 to CNH America LLC, which is incorporated by reference herein in its entirety and for all purposes, agricultural combines comprise a variety of apparatus and systems for receiving and processing crops. In particular, a combine will include a header operable for severing crops and other plant material from root structure and conveying the severed crop and plant material to a feeder of the combine. The feeder will typically include an enclosed feeder housing containing a conveyor mechanism, which conveying mechanism will typically include parallel chains connected by slats, which chains encircle sprockets which are driven by a feeder drive to move the chains and slats upwardly and rearwardly along a floor of the housing, for inducting and conveying the crop and plant material, as well as debris that may be contained therein, into an inlet region of a threshing system of the combine. The threshing system, in turn, will typically include at least one rotor rotatable within a cavity or space defined at least partially by a concave structure having an array or arrays of openings therein sized for passage of grain therethrough. The rotor will include elements for inducting the crop and other material into the cavity and conveying the material through a crop separation clearance between the outer region of the rotor and the inner region of the concave, for separating grain and other small elements of the crop material from larger elements thereof, typically including leaves, stalks, cobs, husks and the like, depending on the crop being harvested. The separated grain is then expected to pass through the openings of the concave for further processing.

From time to time during operation of an agricultural combine, a slug, that is, an incorrectly processed and/or compacted mass of crop material and/or weeds, particularly stringy or viny weeds, debris, or other material, may be inducted into the feeder and/or threshing system and become lodged or packed or jammed, to possibly interrupt throughput of crop material through the combine, and/or damage to components of the feeder and/or threshing system, thus necessitating removal of the slug. Removal of the slug can entail backing it away from the location within the feeder and/or threshing system at which it became lodged, sufficiently so as to break it up or better process or compact it for passage through the feeder and/or threshing system.

Once a slug has developed in the feeder or threshing system of a combine, a number of different actions depending on, the combine status, the type, severity and location of the slug, may be necessary to effect removal of the slug. For instance, in what can be deemed a simple case, it may be sufficient to repeatedly jog the rotor through small angular movements, until the resulting low impulsive loads breakdown the slug and free it. In a more extreme example, it may be necessary to more violently rock the rotor back and forth in an agitating motion, at different amplitudes and different frequencies, occasionally with an asymmetric motion and relatively large impulsive loads, for extended periods of time, to incrementally dislodge or work the slug free. In an even more extreme example, manual intervention may be required, to open up the rotor/concave/feeder system, and manually clear the slug piece by piece. Sometimes in such more extreme instances components of the rotor/concave/feeder system may be forced out of adjustment or damaged by the slug. Manual removal of a slug can be time-consuming and labor intensive.

Thus, what is sought is a system and method for automatically deslugging the threshing and/or feeder system of an agricultural combine, which overcomes one or more of the shortcomings and limitations set forth above.

### SUMMARY OF THE INVENTION

What is disclosed is a system and method for automatically deslugging the threshing and/or feeder system of a combine, which overcomes one or more of the shortcomings and limitations set forth above.

In one exemplary aspect, in an agricultural combine including a rotor of a threshing system, a concave positioned beneath the rotor, a rotor cage positioned above the rotor, a drive controllably operable for rotating the rotor in opposite first and second rotational directions, a control in operative control of the drive, and a sensor for sensing information representative of load conditions opposing rotation of the rotor, a method for deslugging the threshing system of the agricultural combine comprises steps of: sensing information representative of load conditions opposing rotation of the rotor above a pre-determined threshold, which indicates a slugging condition; activating an actuator, which adjusts one or more de-awning plates connected to the concave from an initial position to a deslugging position, wherein the one or more de-awning plates are at least partially positioned between grates of the concave; rotating the rotor; and sensing information representative of load conditions opposing rotation to determine whether the slugging condition still exists.

In another exemplary aspect, the method for deslugging the threshing system of the agricultural combine comprises steps of: sensing information representative of load conditions opposing rotation of the rotor above a pre-determined threshold, which indicates a slugging condition; activating an actuator, which adjusts one or more vanes connected to the rotor cage from an initial position to a deslugging position; rotating the rotor; and sensing information representative of load conditions opposing rotation to determine whether the slugging condition still exists.

### BRIEF DESCRIPTION OF THE DRAWINGS

Embodiments of inventions will now be described, strictly by way of example, with reference to the accompanying drawings, in which:

FIG. 1 is a side view of an agricultural combine including a feeder and a threshing system adapted for use with the deslugging methods and system of the invention;

FIG. 2 is a simplified and view of a rotor and concave of the threshing system of the combine of FIG. 1, illustrating the concave in an alternative position moved away from the rotor for enlarging a crop separation clearance according to the invention;

FIG. 3 is a simplified schematic of a drive and a control operable for rotating a rotor of the threshing system of the combine of FIG. 1, including for execution of the deslugging methods of the invention;

FIG. 4 is a high-level flow diagram illustrating steps of a method of the invention, including steps of a first selectable deslugging routine of the invention;

FIG. 5 is a continuation of the diagram of FIG. 4;

FIG. 6 is another continuation of the diagram of FIGS. 4 and 5, illustrating steps of a second selectable deslugging routine;

FIG. 7 is another continuation of the diagram of FIGS. 4, 5 and 6, showing steps of a third routine;

FIG. 8 is another continuation of the diagram, illustrating steps of a fourth routine;

FIG. 9 is another continuation of the diagram, illustrating steps of still another deslugging routine;

FIG. 10 is still another continuation of the diagram, illustrating still another deslugging routine;

FIG. 11 is another continuation of the diagram, illustrating still another deslugging routine;

FIG. 12 is yet another continuation of the diagram, illustrating still another deslugging routine;

FIG. 13 is an isometric view of a threshing system and a crop residue distribution system of a combine, the isometric view taken from the discharge side of the combine; and

FIG. 14 is an isometric view showing de-awning plates attached to the concave of the combine.

### DETAILED DESCRIPTION OF THE DRAWINGS

Exemplary embodiments of the present invention provide a system and method for deslugging a threshing system of an agricultural vehicle. The methods and apparatus may be used in agricultural combines, as described in the examples, but it will be appreciated that other embodiments may be used in other types of machines having a similar arrangement of parts, upon incorporation of the appropriate features of the inventions herein.

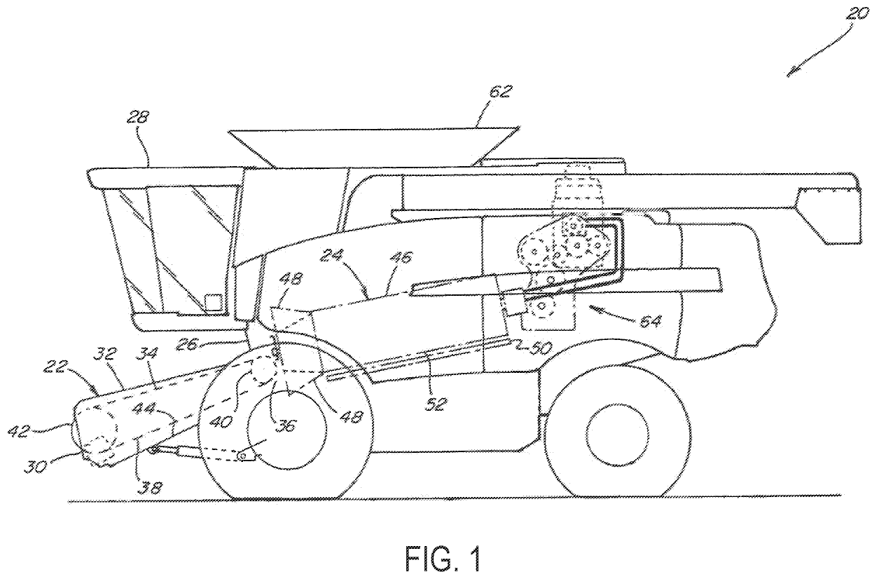

Referring now to the drawings wherein like numerals refer to like parts, as is described in U.S. Pat. No. 7,452,267 to CNH America LLC, in FIG. 1 an agricultural combine 20 is shown, including a feeder 22, and a threshing system 24, each of which is adapted for use with a deslugging method and system of the invention, as will be explained hereinafter.

Feeder 22 is mounted on a front end 26 of combine 20 generally beneath an operator cab 28. A header (not shown) is mountable on a forward end 30 of feeder 22, and is constructed and operable in the well-known manner for severing crops and other plant material from the ground as combine 20 is moved forwardly thereover, and conveying the cut crops and other plant material to an inlet opening on forward end 30 of feeder 22. Feeder 22 includes a feeder housing 32 containing a feed conveyor 34 operable for conveying the crops and other plant material upwardly and rearwardly through housing 32 into an inlet region 36 of threshing system 24. Feed conveyor 34 generally includes at least two endless chains 38 encircling drive sprockets 40 located in the rear end of feeder housing 32 and a drum 42 located in the forward end 30. A plurality of slats (not shown) extend between chains 38 and facilitate the conveying of the crop and other material through housing 32, in the well-known manner. In this latter regard, drive sprockets 40 will be rotated in a counterclockwise direction, for moving chains 38 and the slats upwardly and rearwardly along a floor 44 of housing 32, for conveying the crops and other material upwardly and rearwardly in that direction along the floor 44 to inlet region 36, also as is well known.

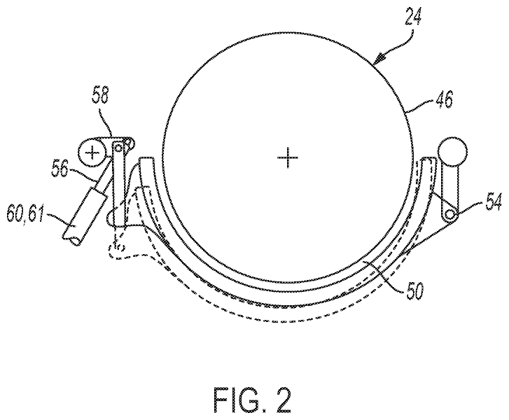

Referring also to FIG. 2, threshing system 24 includes a rotatable, generally cylindrical rotor 46 including a tapered forward end having at least two vanes or flights 48 (FIG. 1) extending radially outwardly therefrom. At least the lower region of rotor 46 rearwardly of flights 48 is surrounded by a concave 50 located in radially outwardly spaced relation thereto, defining a crop separation clearance 52 extending circumferentially at least partially around the outer cylindrical surface of rotor 46. Referring more particularly to FIG. 2, concave 50 is supported beneath rotor 46 by a support structure including a pivotal connection 54 on one side, and one or more hanger straps 56 on the other side. Hanger strap 56 is connected to a free end of an adjusting arm 58 supported and controllably movable upwardly and downwardly by an actuator 60, which can be, for instance, an electric gear motor or a fluid cylinder. Actuator 60 is of well-known, conventional construction, and can be controlled by an operator using a control (not shown) in cab 28 in the well-known manner to precisely position concave 50 within a range of relatively more closely spaced positions in relation to rotor 46 (represented in solid lines) providing a crop separation clearance suitable for separation of grain from other crop material as rotor 46 is rotated. The position of concave 50 can be sensed or determined in the conventional, well known manner using a concave position sensor 61, which can be associated with or incorporated into actuator 60, or located elsewhere for sensing information representative of the position of concave 50 relative to rotor 46. Actuator 60 can also be controlled in the same manner to position concave 50 in at least one lowered position (represented in dotted lines) wherein the crop separation clearance is opened so as to be suitable for facilitating deslugging operations according to the present invention, as will be explained. In some instances, concave 50 may be constructed or supported so as to automatically drop or open to a lowered position, as a result of loads applied there against such as can result from a slug.

In operation, actuator 60 will be used to adjust the position of concave 50 and thus crop separation clearance 52, to provide desired threshing characteristics for the crop to be harvested and yields, under conditions present during the harvesting operation. As combine 20 is moved forwardly through a field, crops and other plants severed by the header (not shown) will be conveyed to feeder 22, and through feeder 22 to threshing system 24, wherein a mat of the crop and other plant material will move in a generally helical path through crop separation clearance 52, as effected by rotation of rotor 46. Grain and other small elements of plant material will then pass through arrays of openings or spaces in concave 50, so as to fall therefrom onto a cleaning system (not shown) of combine 20, which will further clean the grain from the other small elements of plant material. From the cleaning system, the clean grain will be conveyed into a clean grain tank 62, in the well-known conventional manner. Larger elements of plant material, such as straw, leaves, stalks, cobs, and the like, which do not pass through the openings of concave 50 are conveyed through crop separation clearance 52 past the rear end of rotor 46 and concave 50, and are disposed of through the rear end of combine 20, also in the well-known manner.

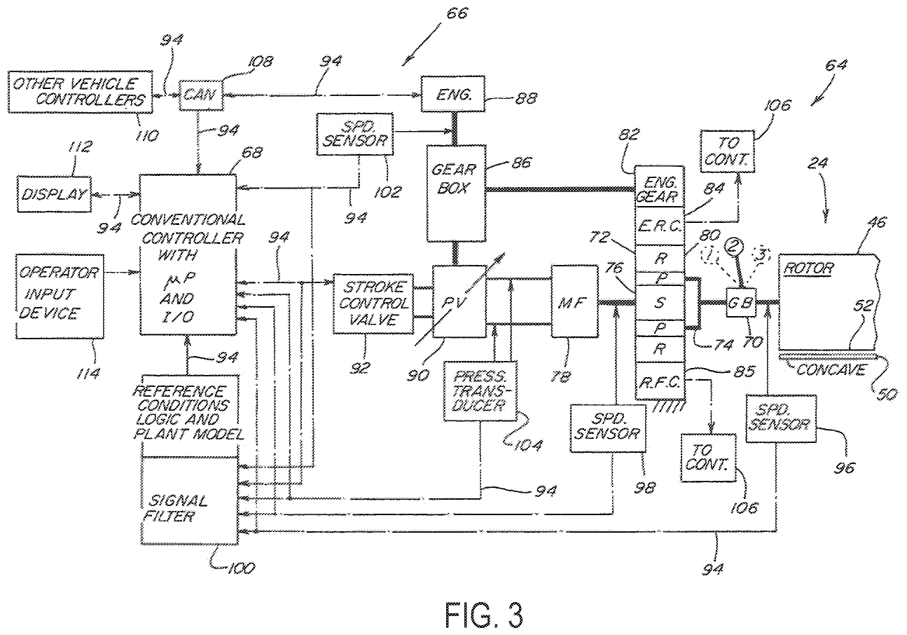

Referring also to FIG. 3, a drive 64 is connected in rotatably driving relation to rotor 46, and is controllably operable for rotating rotor 46 relative to concave 50, for threshing harvested crops as just explained. A control 66, preferably including a microprocessor based controller 68, is connected in operative control of drive 64, and with drive 64, comprises the system for deslugging threshing system 24 according to the teachings of the present invention.

Drive 64 (optionally) includes a multiple speed transmission or gearbox 70 connected to rotor 46 for rotation therewith; a planetary gear arrangement 72 having a carrier 74 connected to gearbox 70 for rotation therewith; and a sun gear 76 in rotatable connection with a fluid motor 78. A ring gear 80 of arrangement 72 is rotatably connectable to an engine gear 82 by an engine to ring clutch 84. Engine gear 82, in turn, is rotatably connected via a gearbox 86 to an engine 88. Ring gear 80 is also connectable to the frame of the combine by a ring to frame clutch 85. Fluid motor 78 is connected in a fluid loop with a variable displacement fluid pump 90 for receiving pressurized fluid therefrom, the displacement of pump 90 being controllable by a stroke control valve 92. Stroke control valve 92 is connected via a conductive path 94 to controller 68 of control 66 for receiving control commands therefrom and outputting signals representative of stroke position thereto. Drive 64 may vary from that which is shown and described.

Control 66 includes several sensors for sensing information representative of the operating state and conditions of drive 64, including speed sensors 96 and 98 connected via conductive path 94 to controller 68, and also to a signal processing filter 100, which can be, for instance, a simplified Kalman type signal filter, or other suitable signal filtering and processing routine or device having capabilities useful for the purposes of the present invention. Speed sensors 96 and 98 are operable for sensing information representative of speeds of rotor 46 and sun gear 76, respectively, and outputting information representative thereof to controller 68. Another speed sensor 102 is connected via a conductive path 94 to controller 68 and is operable for sensing information representative of a speed of engine 88 and outputting the information to the controller. A pressure transducer 104 is connected via a conductive path 94 to controller 68 and to filter 100, and is operable for sensing pressure conditions in fluid lines extending to and from motor 78 and outputting information representative thereof to the controller and filter. These sensors are either individually or collectively utilized to sense load conditions opposing rotation of the rotor.

Still further, engine to ring clutch 84 and ring to frame clutch 85 are connected to controller 68, as indicated by boxes 106, for control thereby for rotatably connecting and disconnecting ring gear 80 and engine gear 82, and ring gear 80 and the frame of the machine, respectively. Control 66 is also connected by a controller area network (CAN) 108 to engine 88 and other vehicle controllers and systems, generally denoted by box 110, via suitable conductive paths 94. Controller 68 additionally is connected via one or more conductive paths 94 to one or more displays 112, and one or more operator input devices 114, located for instance, in operator cab 28, operable for displaying information, and inputting operator commands to control 66, respectively.

For operation in a threshing mode, an operator will select a gear range of gearbox 70 for achieving a desired rotational speed range for rotor 46, which is typically dependent on the crop type and any of a variety of other conditions, and pump 90 will be stroked and ring to frame clutch 85 and engine to ring clutch 84 sequentially engaged, as required, for achieving a desired rotor speed by a combination of hydrostatic and hydro-mechanic acceleration and speed control. Concave 50 will be positioned using actuator 60 (FIG. 2) as required for achieving a desired crop separation clearance 52. The speed of rotation of rotor 46 within the selected speed range can be varied by varying the stroke of pump 90, the state of engagement or disengagement of engine to ring clutch 84 and engine speed, and will also be affected by other factors such as crop loads and conditions, particularly the presence of a slug.

During normal harvesting, the commands outputted by controller 68 to stroke control valve 92, and information outputted by valve 92; information outputted by speed sensors 96, 98 and 102; and pressure information from transducer 104, are inputted to control 66 for processing by filter 100, wherein they can be used for modeling the threshing operation, particularly to estimate or predict the current state thereof to discern the, particularly relating to the presence of, and extent of, any slugging conditions. Likewise, during a deslugging routine or routines, this information can be utilized by controller 68 using filter 100 for evaluation of effectiveness of the routine or routines for present conditions, location and extent of a slugging condition, for use in selecting a subsequent deslugging routine. All deslugging processes may be executed in the hydrostatic state with ring to frame clutch 85 engaged and engine to ring clutch 84 disengaged. The hydrostatic state permits forward and reverse rotary control.

The method and system of the invention provides several operator or automatically selectable automatic routines or methods of operation of a drive, such as drive 64, by a control, such as control 66, for rotating a rotor of a threshing system, such as rotor 46, for dislodging, breaking up or freeing slugs or clogs of plant material and/or debris from the crop separation clearance between the rotor and the concave.

Non-limiting examples of automatic deslugging routines of the invention include reciprocating actions or movements of controlled travel or extent, which will be a function of direction and duration of rotational movement of the rotor at the selected speed. Others automatically vary or alter the direction and/or duration of rotation in a direction responsive to sensed conditions representative of, for instance, opposition to the rotation resulting from a slug, and/or the position or movements of a slug about the concave, again filter 100 being usable for estimating the states of the threshing system for discerning the existence of and pertinent parameters of any slugs.

Another routine includes automatically rotating the rotor alternatingly in the first and second rotational directions through progressively increasing increments of rotational travel. As another routine, the rotor is automatically rotated alternatingly in the first and second rotational directions through increasing increments of rotational movement while the sensed information representative of loads opposing the rotation is monitored for information representative of a predetermined load level, which can be indicative of characteristics of a slugging condition, or success of the deslugging routine. This, and possibly other sensed information, as well as information representative of a state or states of the threshing system, can be used by control 66 for estimating a future state or states of the system, using filter 100. Then, at least one subsequent increment of rotational movement is automatically altered responsive to presence of the information representative of the predetermined load level. Thus, for instance, a predetermined load level can represent contact with a slug, and the alteration of the subsequent increment of rotation can include, for instance, but is not limited to, increasing an extent of a subsequent increment of rotation in the rotational direction for which the predetermined load level is present, or changing speed of rotation, so as to be more effective for dislodging, breaking up or freeing a slug. Another routine is an agitating routine wherein the rotor is reciprocally moved in an agitating motion which can have predetermined or settable characteristics which can include, but are not limited to, profile, amplitude, frequency, waveform symmetry and duration. Any of these characteristics can be adapted or modified based on changes between a past state of the system and the current state as estimated or predicted using filter 100.

Another routine is a jogging routine wherein the rotor is jogged in angular increments relative to the concave.

As noted above, a deslugging routine or strategy selection may be based upon any of a number of considerations or factors, such as the nature or type of crop being harvested, characteristics of the slugging condition, such as loads that arise during operation of the threshing system and/or initial deslugging steps which may be manually executed or automatic.

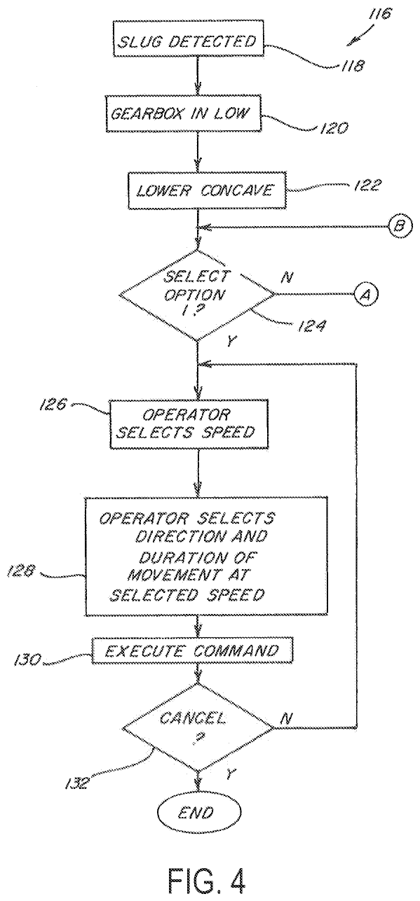

Preferred steps of exemplary routines of the method and system of the invention are illustrated in FIGS. 4-12. Referring more particularly to FIGS. 3 and 4, in a flow diagram 116, once a slug or slugging condition of a threshing system such as threshing system 24 is detected, a warning may be outputted to the operator, and the rotor will be brought to a halt. In each instance, as denoted at block 118, the multiple speed gearbox (if any) will preferably be shifted to a low gear (for increased torque) if not already in low, and the concave will be lowered to increase the crop separation clearance, as denoted by blocks 120 and 122. Steps 120 and 122 can be performed by the operator, or automatically. Next, for instance utilizing display 112, several selectable deslugging routines will be displayed and can be selected using, for instance, input device 114.

At decision block 124, controller 68 will determine if option 1 of the several options is selected. If so, the operator will input a speed and select a direction and duration of movement of rotor 46, as denoted at blocks 126 and 128. This can include a single direction of movement, or an initial direction. In the former instance, if only a single speed, direction and duration of movement are selected, when executed, as denoted at block 130, controller 68 will responsively automatically initiate and execute a controlled rotation of rotor 46 in a corresponding manner. In the latter instance, controller 68 will responsively automatically execute a controlled rotation of rotor 46 in the first selected direction at the selected speed for the selected duration, then reverse the direction of rotation and rotate rotor 46 in the opposite direction at the selected speed for the selected duration. Controller 68 will then determine whether the routine is to be canceled, as denoted at decision block 132, and if not, will return to block 126 and loop through execution block 130. Cancellation can be by the operator, or automatic, for instance, as a result of the occurrence of some condition, such as dislodgement of the slug.

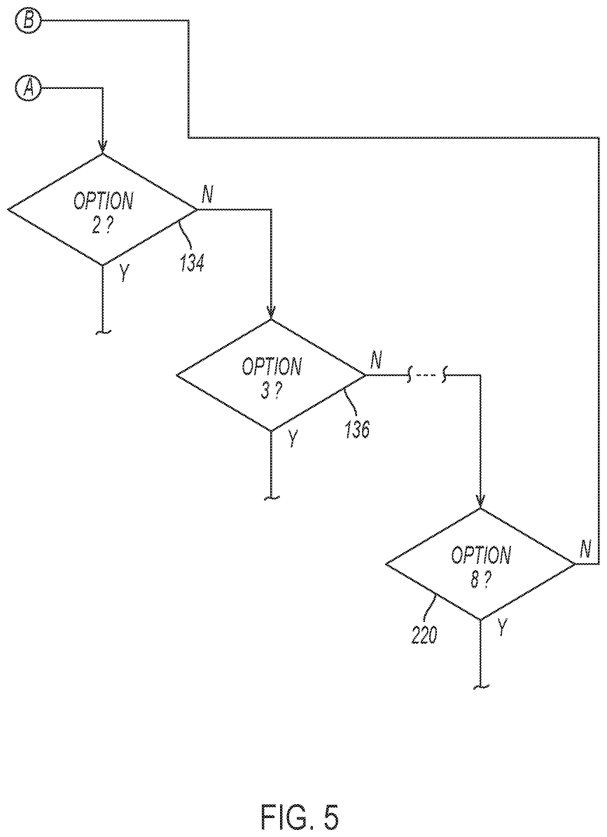

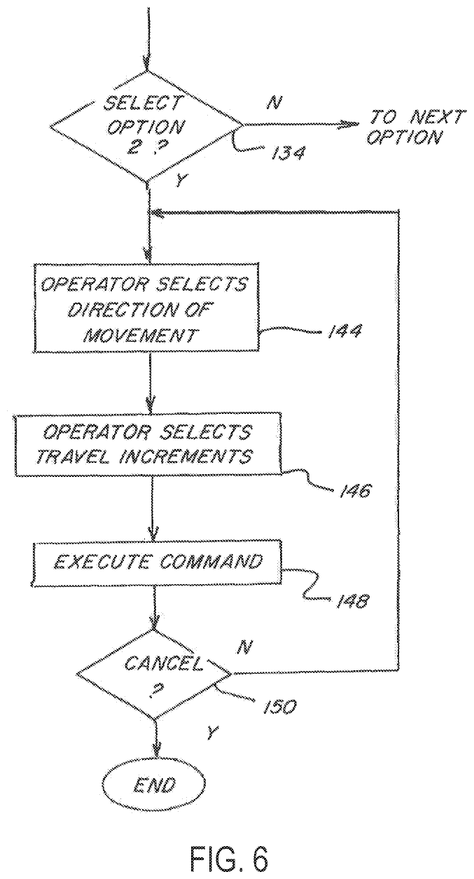

Returning to decision block 124, and also viewing FIGS. 5-12, if option 1 is not selected, controller 68 will determine if option 2 is selected (FIGS. 5 and 6), as denoted at decision block 134, and if that option is not selected, will proceed to sequentially determine whether any of the subsequent available options are selected, as denoted by the sequence of decision blocks 136, 138, 140, 142, 200 and 220. Here, it should be recognized and understood that, although eight optional selectable deslugging routines are presented, a greater or lesser number can be utilized within the teachings of the present invention.

Going through the exemplary options, as illustrated in FIG. 6, if option 2 is selected, the operator will select a direction of movement, as denoted at block 144, and a travel increment, as denoted at block 146. Controller 68 will then execute the commanded routine as denoted at block 148. The routine can then be canceled, as denoted at decision block 150, or the direction of movement and travel increment changed as the controller loops through blocks 144, 146, 148 and 150. Cancellation can again be automatic, for instance, responsive to a sensed condition or information indicative of dislodgment or clearance of a slug, such as a reduced sensed pressure condition during rotation of the rotor, as can be determined by estimating or predicting the present or future state of the threshing system using filter 100.

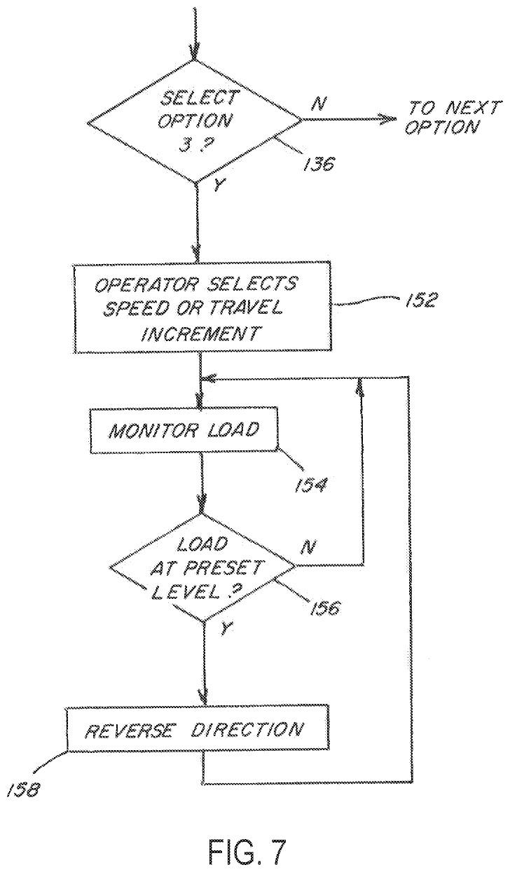

As illustrated in FIG. 7, if option 3 is selected, the operator will select a speed or travel increment, as denoted at block 152. Controller 68 will then rotate rotor 46 at the selected speed and/or increment while monitoring loading conditions exerted in response to the rotation, as denoted at block 154. If the monitored load does not reach a predetermined or preset level, as determined at decision block 156, controller 68 will loop through the steps of blocks 154 and 156 until the level is reached, or the routine is canceled, again, either by the operator or automatically. If the preset load level is reached, controller 68 will reverse the direction of rotation, as denoted at block 158 and return to block 154, and again monitor the loading conditions. If the preset loading level is not reached, the controller will continue to rotate the rotor in the latest direction while looping through the steps of blocks 154 and 156. If, at block 156 it is determined that the preset load level has been reached, the direction of rotation will again be reversed and the controller will continue to monitor loads. As a result, rotor 46 will be alternatingly rotated at the selected speed, and/or to the selected extent of travel, in the opposite directions, responsive to the reaching of the preset load level. This routine will be repeated, or can be canceled after some condition is met or detected.

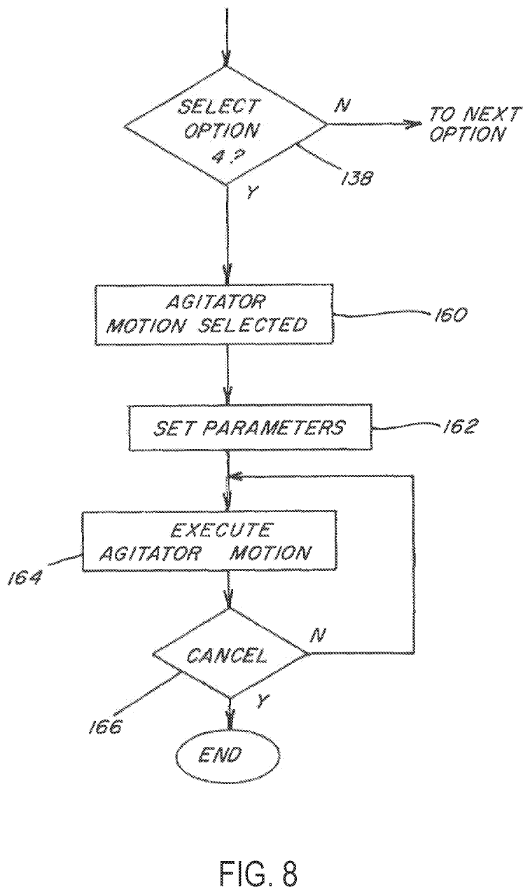

In FIGS. 8-12, steps of several agitating routines are illustrated.

Referring to FIG. 8, if, at decision block 138 option 4 is selected, an agitation motion is selected, as denoted at block 160. As a result, controller 68 will prompt the operator to select preset parameters of the agitator motion or set new parameters, as summarized at block 162. Such parameters can include, but are not limited to, speed of rotation, motion profile, amplitude, frequency, waveform symmetry and duration. Once the parameters are set, controller 68 will execute the agitator motion, as denoted at block 164, until the routine is canceled, as denoted at decision block 166. Again, cancellation can be initiated by operator action, or automatically. Any of the parameters, for instance, frequency, can be modified automatically by controller 68, based on the estimated state of the threshing system determined using filter 100.

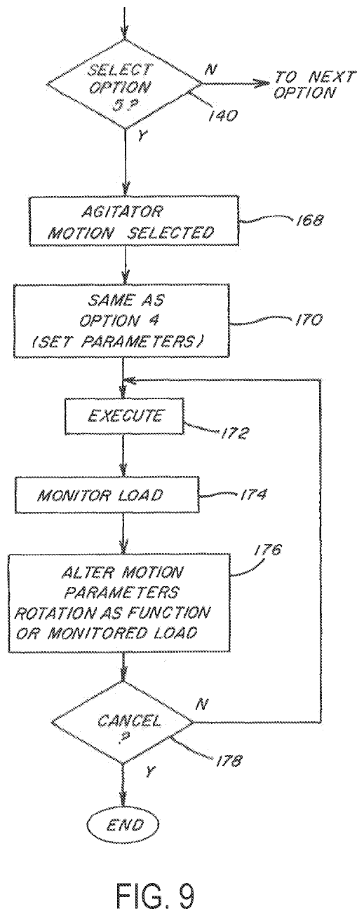

Also referring to FIG. 9, a fifth option is an agitator motion routine wherein during the execution of the routine, loading conditions are monitored and the motion parameters (e.g., speed, profile, amplitude, frequency, waveform symmetry and/or duration) are automatically altered as a function of the monitored load, as denoted by the sequence of steps of blocks 168, 170, 172, 174 and 176. This sequence of steps will be repeated in a looping action until canceled, as denoted by block 178.

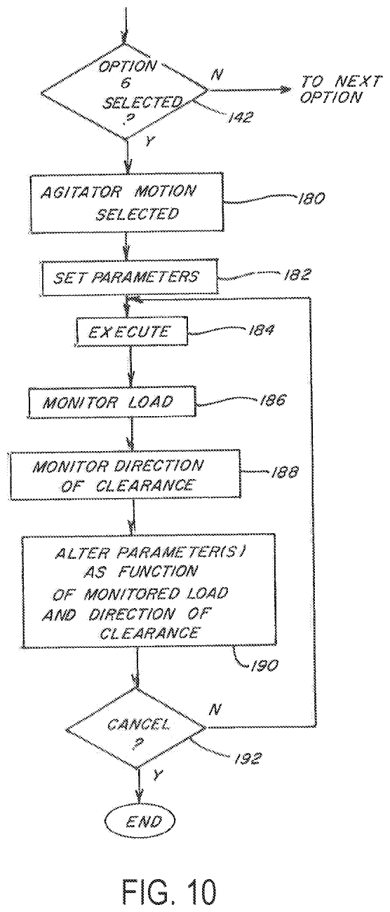

Referring to FIG. 10, selection of a sixth option, as denoted at block 142, will initiate operation in an agitator motion, as denoted at block 180, wherein the loading conditions will be monitored, as well as a direction of clearance. In this mode, parameters of the agitator motion (speed, profile, amplitude, frequency, waveform symmetry and/or duration) are set, as denoted at block 182, and can be individually selected by the operator, or can be predetermined or preset. Controller 68 will then execute the agitator motion, as denoted at block 184. During the rotation of rotor 46 in the agitator motion, controller 68 will monitor both load and direction of clearance, as denoted at blocks 186 and 188. Here, direction of clearance connotes a direction of rotation which is not impeded or is less impeded by the slug sought to be cleared or dislodged. That is, when rotor 46 is rotated in one direction, elevated loading conditions will be encountered which will be indicative of encountering the slug, which elevated loading conditions will not be encountered or will be less when rotor 46 is rotated in the opposite direction. Such elevated loading conditions can be determined as a function of pressure conditions sensed by transducer 104. As a result of the presence of such elevated loading conditions and information representative of the direction of rotation in which such loading conditions are encountered, one or more of the motion parameters can be altered, to effect a successful deslugging strategy, as denoted at block 190. After execution of the altered motion, if conditions indicative of clearing of the slug are present (e.g. reduced pressure when rotating the rotor in the direction wherein the elevated loading conditions were encountered), the routine can be canceled, either by an operator or automatically, as denoted at block 192.

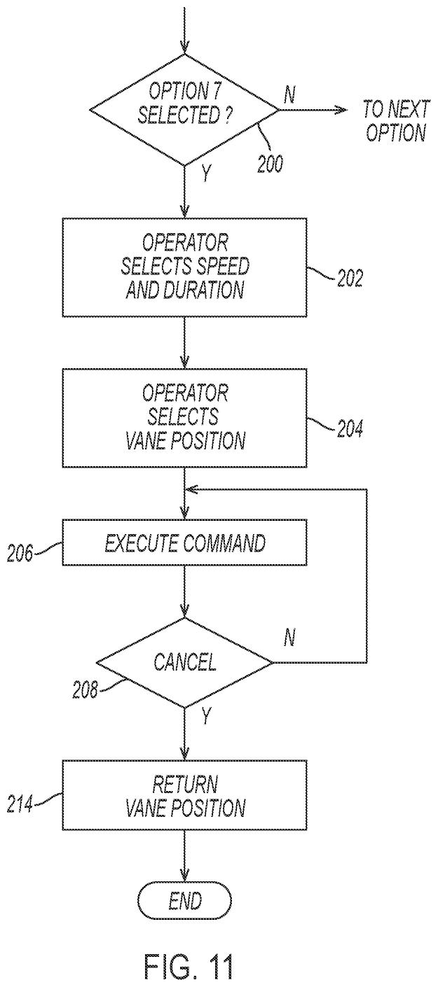

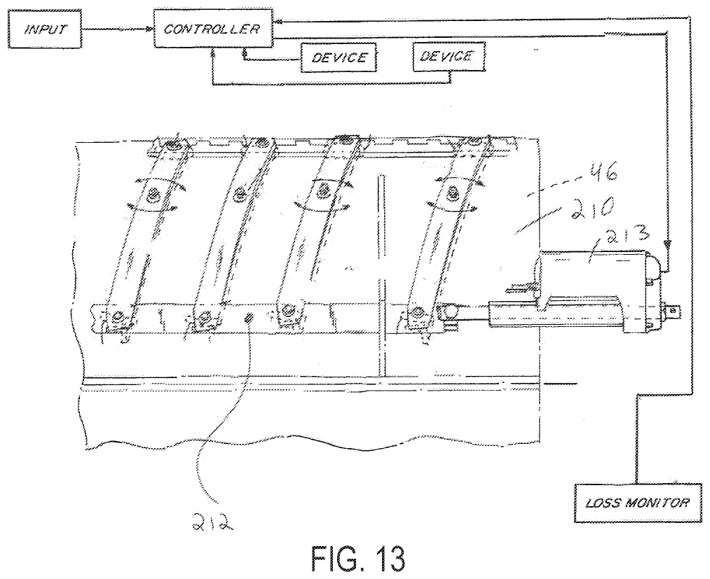

Referring now to FIGS. 11 and 13, if, at decision block 200, option 7 is selected, the operator will input a speed, direction and duration of movement of rotor 46, as denoted at block 202. Rotation of rotor 46 may be either forward or reverse. The operator then inputs a vane position for the threshing vanes 212, as denoted by block 204. Vanes 212 may have a known “de-slugging position” which will ease the passage of a slug through the threshing system of the combine.

As is described in U.S. Patent App. Pub. No. 2011/0320087 to CNH Industrial America LLC, FIG. 3 of which is renumbered herein as FIG. 13, it is known to utilize a plurality of threshing vanes 212 on the inner surface of a threshing rotor cage 210 surrounding the top side of rotor 46 to assist in guiding or directing the movement of the crop material through the threshing system of a combine. It is further known that such vanes can be moved and secured in several positions or orientations, namely, pitch angles, for a variety of reasons, including for different crop types or conditions. U.S. Patent App. Pub. No. 2011/0320087 as well as U.S. Pat. Nos. 10,426,093; 4,244,380; 7,473,170, each of which is incorporated by reference herein in its entirety and for all purposes, describe movable vanes in a threshing system. U.S. Patent App. Pub. No. 2011/0320087 and U.S. Pat. No. 10,426,093, in particular, describe automated mechanisms such as actuator 213 for moving the vanes. The details regarding automated movement of the threshing vanes may be gleaned from those references and are not repeated herein.

Referring still to FIG. 11, once the parameters are set, controller 68 will execute the rotation of the rotor 46 and movement of one or more vanes 212, as denoted at block 206, until the routine is canceled, as denoted at decision block 208. Vanes 212 may be moved prior to rotating rotor 46. During rotation of rotor 46, controller 68 will monitor load on rotor 46 to determine the existence and/or dislodgement of the slug. Again, cancellation can be initiated by operator action, or automatically, for instance, as a result of the occurrence of some condition, such as dislodgement of the slug. Any of the parameters can be modified automatically by controller 68, based on the estimated state of the threshing system determined using filter 100. Upon cancellation of the routine, vanes 212 are returned to their original position, as denoted by block 214.

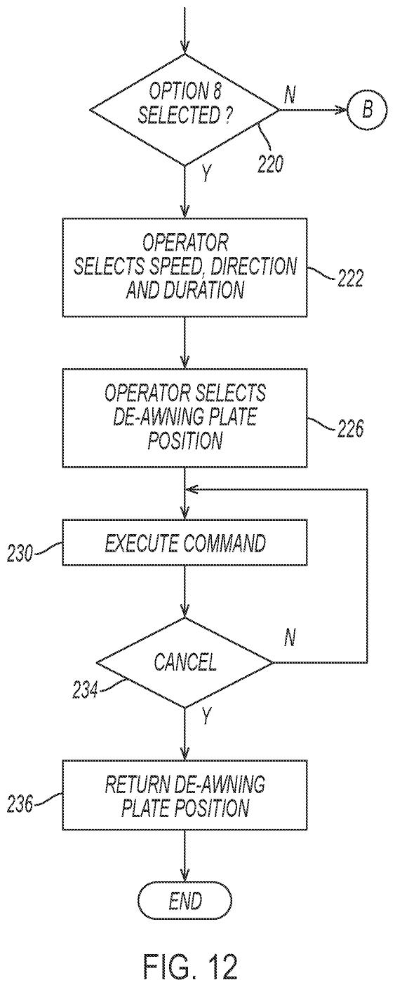

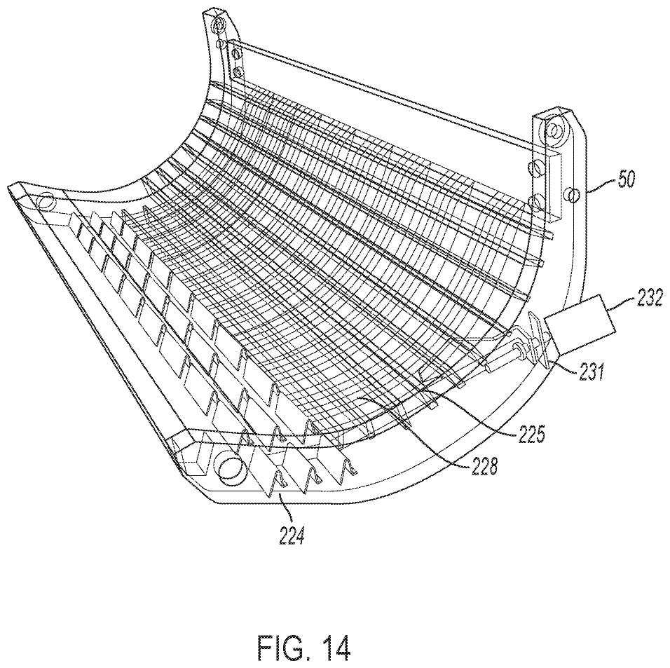

Referring now to FIGS. 12 and 14, if, at decision block 220, option 8 is selected, the operator will input a direction, speed and duration of movement of rotor 46, as denoted at block 222. Rotation of rotor 46 may be either forward or reverse. The operator then inputs a tilting position for the de-awning plates 224, as denoted by block 226. De-awning plates 224 may have a known “de-slugging position” which will ease the passage of a slug through the threshing system of the combine.

De-awning plates 224, three of which are shown in FIG. 14, are plates that are mounted to concave 50 for metering the amount of grain that is permitted to pass through the grates 228 of concave 50. The individual plates 224 are rectangular plates that are positioned either adjacent or between grates 228. Plates 224 run in the longitudinal direction. Plates 224 are mounted together by a linkage 225 such that movement of linkage 225 causes plates 224 to simultaneously rotate about their longitudinal axes relative to the stationary grates 228. The linkage 225 is a bar having one end that is mounted to a stationary bracket 231 and an opposing end that is mounted to each of plates 224. In the open position of the plates 224 (as shown) a maximum amount of grain passes through grates 228. In the closed position of plates 224 (not shown), a reduced amount of grain passes through grates 228. An actuator 232, in the form of an electric motor (for example), adjusts linkage 225 for moving de-awning plates 224 between the closed and open positions. Actuator 232 is controlled by controller 68. One or more feedback sensors, which communicate with controller 68, may be provided to control rotation of plates 224 relative to grates 228. Those skilled in the art will recognize that other styles of de-awning plates exist, thus, the de-awning plates are not limited to those shown and described. Also, other mechanisms exists for moving de-awning plates 224 between the closed and open positions.

Referring still to FIG. 12, once the parameters are set, controller 68 will execute the rotation of the rotor 46 and movement of plates 224, as denoted at block 230, until the routine is canceled, as denoted at decision block 234. Plates 224 may be moved prior to rotating rotor 46. During rotation of rotor 46, controller 68 will monitor the load on rotor 46 to determine the existence and/or dislodgement of the slug. Again, cancellation can be initiated by operator action, or automatically, for instance, as a result of the occurrence of some condition, such as dislodgement of the slug. Any of the parameters can be modified automatically by controller 68, based on the estimated state of the threshing system determined using filter 100. Upon cancellation of the routine, plates 224 are returned to their original position, as denoted by block 236.

Any of the parameters for the deslugging routines just discussed, can be modified automatically by controller 68, based on the estimated state of the threshing system determined using filter 100. Additionally, during or after the execution of at least one of the deslugging routines, controller 68 can be programmed to automatically collect and store information representative of at least loading conditions sensed during the execution, for instance as filtered and processed using filter 100, and automatically select a subsequent deslugging routine for execution as a function of the stored information and/or modeled system. A deslugging routine or strategy selection may be adapted and based upon any of a number of considerations or factors, such as the nature or type of crop being harvested, characteristics of the slugging condition, such as loads that arise during operation of the threshing system and/or initial deslugging steps which may be manually executed or automatic.

As a result of the above disclosure, it should be apparent that the deslugging method and system of the invention have utility for improving the ability to effectively dislodge, break up and/or free slugs from a threshing system of a combine, such as system 24 of combine 20, while decreasing occurrences of problems such as damage to the threshing system or drive, which can occur as a result of a variety of factors such as inappropriate speeds, impulse loading conditions, and the like. It should also be apparent that the automatic deslugging routines of the invention can be executed in a more controlled and precise manner, compared to execution of similar routines under operator control wherein operator skill level, experience and other factors will impact the effectiveness. For instance in this regard, the ability of the system of the invention to monitor and respond to sensed loading condition will be expected to be substantially better than the response of an operator to such conditions, at least in part as a result of the signal filtering and processing using filter 100. It should also be understood that although the preferred signal processing filter 100 is of the simplified Kalman type, other suitable filters or routines may be used by control 66 for discerning the state of the threshing system for the purposes of the present invention.

It should also be recognized and understood that the method and system of the invention can be applied to operation of a feed conveyor, such as conveyor 34 of feeder 22.

It is to be understood that the operational steps are performed by the controller 68 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 68 described herein is implemented in software code or instructions which are tangibly stored on a tangible computer readable medium. Upon loading and executing such software code or instructions by the controller 68, the controller may perform any of the functionality of the controller described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiments of the invention; however, concepts, as based upon the description, may be employed in other embodiments without departing from the scope of the invention. Accordingly, the following claims are intended to protect the invention broadly as well as in the specific form shown.

What is claimed is:

1. In an agricultural combine including a rotor of a threshing system, a concave positioned beneath the rotor, a rotor cage positioned above the rotor, a drive controllably operable for rotating the rotor in opposite first and second rotational directions, a control in operative control of the drive, and a sensor for sensing information representative of load conditions opposing rotation of the rotor, a method for deslugging the threshing system of the agricultural combine comprises steps of:
sensing information representative of load conditions opposing rotation of the rotor above a pre-determined threshold, which indicates a slugging condition;
activating an actuator, which adjusts one or more vanes connected to the rotor cage from an initial position to a deslugging position;
rotating the rotor; and
sensing information representative of load conditions opposing rotation to determine whether the slugging condition still exists.

2. The method of claim 1, further comprising moving the concave in a direction away from the rotor for increasing a separation clearance between the concave and the rotor.

3. The method of claim 1, further comprising actuating the actuator to return the vanes connected to the rotor cage to the initial position.

4. The method of claim 1, further comprising automatically terminating the method when information representative of successful deslugging of the threshing system is present.

5. The method of claim 4, wherein the information representative of successful deslugging of the threshing system comprises sensing a decreased load condition opposing the rotation of the rotor indicative of dislodging of a blockage from between the rotor and the concave.

6. The method of claim 1, wherein during or after the method, the control automatically stores information representative of at least loading conditions sensed by the sensor, and automatically selects a subsequent deslugging routine for execution as a function of the stored information.

7. The method of claim 6, wherein the subsequent deslugging routine comprises activating another actuator, which adjusts one or more de-awning plates from an initial position to a deslugging position, wherein the one or more de-awning plates are each at least partially positioned between grates of the concave.

8. The method of claim 7, further comprising activating said another actuator to return the de-awning plate to the initial position.

9. The method of claim 1, wherein the drive comprises a fluid driven motor, and the information representative of the predetermined loading condition opposing the rotation is determined as a function of a pressure condition of fluid driving the motor.

10. The method of claim 1, further comprising a second sensor for sensing information representative of a speed of rotation of the rotor, and the information representative of the predetermined loading condition opposing the rotation is determined as a function of sensed information representative of a speed of rotation of the rotor.

11. The method of claim 1, wherein the drive comprises a multiple speed range transmission, and the method comprises a step of selecting a low transmission speed range prior to initiating the step of rotation of the rotor.

12. In an agricultural combine including a rotor of a threshing system, a concave positioned beneath the rotor, a rotor cage positioned above the rotor, a drive controllably operable for rotating the rotor in opposite first and second rotational directions, a control in operative control of the drive, and a sensor for sensing information representative of load conditions opposing rotation of the rotor, a method for deslugging the threshing system of the agricultural combine comprises steps of:
sensing information representative of load conditions opposing rotation of the rotor above a pre-determined threshold, which indicates a slugging condition;
activating an actuator, which adjusts one or more de-awning plates from an initial position to a deslugging position, wherein the one or more de-awning plates are each at least partially positioned between grates of the concave;
rotating the rotor; and
sensing information representative of load conditions opposing rotation to determine whether the slugging condition still exists.

13. The method of claim 12, further comprising moving the concave in a direction away from the rotor for increasing a separation clearance between the concave and the rotor.

14. The method of claim 12, further comprising actuating the actuator to return the de-awning plates to the initial position.

15. The method of claim 12, further comprising automatically terminating the method when information representative of successful deslugging of the threshing system is present.

16. The method of claim 12, wherein during or after the method, the control automatically stores information representative of at least loading conditions sensed by the sensor, and automatically selects a subsequent deslugging routine for execution as a function of the stored information.

17. The method of claim 16, wherein the subsequent deslugging routine comprises activating another actuator, which adjusts one or more vanes connected to the rotor cage from an initial position to a deslugging position.

18. The method of claim 12, further comprising providing a second sensor for sensing information representative of a speed of rotation of the rotor, and the information representative of the predetermined loading condition opposing the rotation is determined as a function of sensed information representative of the speed of rotation of the rotor.

19. The method of claim 12, wherein the drive comprises a multiple speed range transmission, and the method comprises a step of selecting a low transmission speed range prior to initiating the rotation of the rotor.

20. The method of claim 12, wherein the drive comprises a fluid driven motor, and the information representative of the predetermined loading condition opposing the rotation is determined as a function of a pressure condition of fluid driving the motor.
